(19) United States
(12) Patent Application Publication
(10) Pub. No.: US 2016/0103669 A1
(43) Pub. Date: Apr. 14, 2016

(54) Installing and Configuring a Probe in a Distributed Computing Environment

(71) Applicants: Nimal K. K. Gamage, Fort Collins, CO (US); Jeffrey Daniel Alley, Fort Collins, CO (US); Eric Matthew Grunzke, Fort Collins, CO (US)

(72) Inventors: Nimal K. K. Gamage, Fort Collins, CO (US); Jeffrey Daniel Alley, Fort Collins, CO (US); Eric Matthew Grunzke, Fort Collins, CO (US)

(21) Appl. No.: 14/512,763

(22) Filed: Oct. 13, 2014

(51) Int. Cl. G06F 9/445; H04L 29/08; H04L 12/26

(52) U.S. Cl. CPC G06F 8/61; H04L 43/12; H04L 67/10

(57) ABSTRACT

In certain embodiments, a method includes accessing, in response to a request to monitor a host device, a first set of discovery information associated with the host device. The first set of discovery information indicates at least one characteristic of the host device. The method further includes determining, based on the first set of discovery information, a second set of discovery information associated with the host device. The method also includes determining, based on the first and second sets of discovery information and based on one or more pre-defined rules, a metric associated with the host device to be monitored. The method includes communicating, based on the metric to be monitored, an installation package to the host device. The installation package includes a probe that is configured to monitor the metric.

### BACKGROUND

This disclosure relates generally to monitorable entities, and more specifically to installing and configuring a probe in a distributed computing environment.

A distributed computing environment typically utilizes various computing systems that may communicate over a network while performing various operations. One or more of these computing systems may be associated with information that may be monitorable.

### BRIEF SUMMARY

In certain embodiments, a method includes accessing, in response to a request to monitor a host device, a first set of discovery information associated with the host device. The first set of discovery information indicates at least one characteristic of the host device. The method further includes determining, based on the first set of discovery information, a second set of discovery information associated with the host device. The method also includes determining, based on the first and second sets of discovery information and based on one or more pre-defined rules, a metric associated with the host device to be monitored. The method includes communicating, based on the metric to be monitored, an installation package to the host device. The installation package includes a probe that is configured to monitor the metric.

Other objects, features, and advantages of the present disclosure are apparent to persons of ordinary skill in the art in view of the following detailed description of the disclosure and the accompanying drawings.

### BRIEF DESCRIPTION OF THE DRAWINGS

Aspects of the present disclosure are illustrated by way of example and are not limited by the accompanying figures with like references indicating like elements.

FIG. 1 illustrates an example of a system for installing and configuring a probe in a distributed computing environment according to one embodiment of the present disclosure.

FIG. 2 illustrates another example of a system for installing and configuring a probe in a distributed computing environment according to one embodiment of the present disclosure.

FIG. 3 illustrates an example of a method for installing and configuring a probe in a distributed computing environment according to one embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely of hardware, entirely of software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

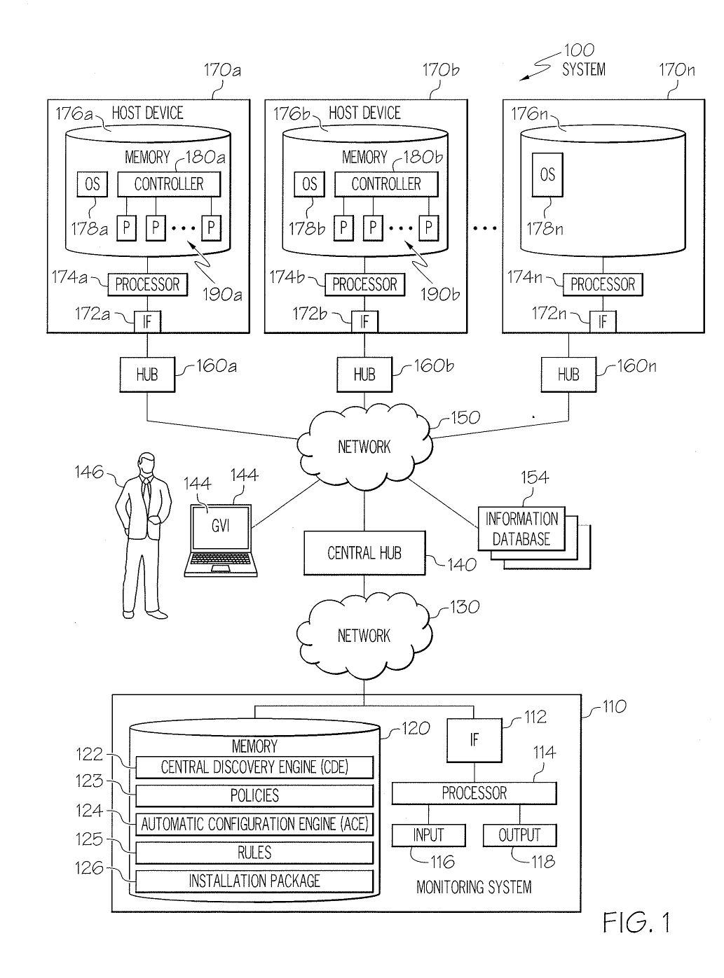

Referring now to FIG. 1, FIG. 1 illustrates an example of a system 100 for installing and configuring a probe in a distributed computing environment according to one embodiment of the present disclosure. In general, system 100 facilitates discovering monitorable information associated with computing devices of a network (e.g., of a service provider network) and installing probes configured to monitor that information on those devices. Thus, system 100 may refer to an automatic system for self-discovery and probing of computing devices of a network. As illustrated, system 100 includes host devices 170, hubs 160 communicatively coupled to host devices 170, and controllers 180 and probes 190 installed on various host devices 170.

In general, system 100 utilizes one or more discovery agents to discover monitorable information associated with host devices 170. Discovery agents may refer to any components operable to access and communicate characteristics of one or more components of host devices 170. For example, discovery agents may include any suitable combination of hubs 160, controllers 180, and probes 190. In certain embodiments, to discover monitorable information, discovery agents may first access discovery information indicating general characteristics of a host device 170, such as a type of operating system installed on a host device 170, network protocol for communicating with a host device 170, information associated with the architecture of a host device 170, host device 170 configuration parameters, and other suitable parameters.

Based on these general characteristics, system 100 may determine more detailed characteristics of a host device 170 to discover. Discovery agents may then access additional discovery information indicating these detailed characteristics, which may include, for example, accessing any suitable combination of information regarding applications installed on a host device 170, information regarding any host device 170 and/or any other devices connected to one or more networks, information regarding virtualization associated with host device 170, information regarding physical servers associated with a host device 170, information regarding websites associated with a host device 170, information regarding storage associated with a host device 170, information regarding bandwidth associated with a host device 170, information regarding cloud computing associated with a host device 170, information regarding end user experience associated with a host device 170, information regarding the architecture of a host device 170, information regarding configuration parameters of a host device 170, any other information associated with a host device 170, and any other suitable information.

System 100 generally uses the discovered information to determine metrics associated with host devices 170 to be monitored. One or more probes 190 configured to monitor those metrics may then be installed on host devices 170. Probes 190 may monitor any metric (e.g., information or data) associated with host devices 170. By monitoring information associated with host devices 170, probes 190 may gather such information for various purposes. For example, at least a portion of the monitored information may be provided for view by a user, at least a portion of the monitored information may be stored (such as for later use and/or for later reference), at least a portion of the monitored information may be processed, grouped, characterized, and/or summarized for view by a user, at least a portion of the monitored information may be compared to one or more thresholds, any other suitable use of the monitored information, or any combination of the preceding.

Host device 170 represents any components operable to process information, and may be implemented using any suitable combination of hardware, firmware, and software. Host device 170 may include any suitable type of computer system, such as a network server, any remote server, a mainframe, a host computer, a workstation, a web space server, a personal computer, a file server, a virtual device, or any other device that may electronically process information. The operations of host device 170 may be performed by any combination of one or more servers or other components at one or more locations. In the embodiment where the module is a server, the server may be a private server, and the server may be a virtual or physical server. The server may include one or more servers at the same or remote locations. Also, host device 170 may include any component that functions as a server. Host device 170 may include an operating system 178 that manages resources and provides services for computer programs installed on host device 170, in certain embodiments. Host device 170 may include (and/or may otherwise be associated with) information that may be monitored. In the illustrated embodiment, host device 170 includes a network interface 172, a processor 174, and a memory 176.

Network interface 172 represents any components operable to receive information from network 150, transmit information through network 150, perform processing of information, communicate to other devices, or any combination of the preceding, and may be implemented using any suitable combination of hardware, firmware, and software. For example, network interface 172 may receive information from hub 160, central hub 140, and/or monitoring system 110. As another example, network interface 150 may communicate information for display to a user 146 on user device 142. Network interface 172 represents any port or connection, real or virtual, including any suitable hardware and/or software, including protocol conversion and data processing capabilities, to communicate through a LAN, a metropolitan area network (MAN), a WAN, or other communication system that allows host device 170 to exchange information with network 150, user device 142, information database 154, or other components of system 100. Although FIG. 1 illustrates system 100 as including only three network interfaces 172 (e.g., network interface 172a, network interface 172b, and network interface 172n), system 100 may include any number of network interfaces 172.

Processor 174 communicatively couples to network interface 172 and memory 176, and controls the operation and administration of host device 170 by processing information received from network interface 172 and memory 176. For example, processor 174 executes operating system 178 to manage resources and provide services for one or more applications and/or computer programs. Processor 174 may be a programmable logic device, a microcontroller, a microprocessor, any processing device, or any combination of the preceding. Although FIG. 1 illustrates system 100 as including only three processors 174 (e.g., processor 174a, processor 174b, and processor 174n), system 100 may include any number of processors 174.

Memory 176 stores, either permanently or temporarily, data, operational software, or other information for processor 174. Memory 176 includes any one or a combination of volatile or non-volatile, local or remote devices suitable for storing information. For example, memory 176 may include RAM, ROM, magnetic storage devices, optical storage devices, or any other information storage device or a combination of these devices. While illustrated as including particular modules, memory 176 may include any information for use in the operation of host device 170. Although FIG. 1 illustrates system 100 as including only three memories 176 (e.g., memory 176a, memory 176b, and memory 176n), system 100 may include any number of memories 176.

In the illustrated embodiment, memory 176 includes operating system 178, controller 180, and probes 190. Operating system 178 represents any suitable set of instructions, logic, or code embodied in a computer readable storage medium and operable to manage resources and provide services for one or more applications and/or computer programs. Operating system 178 may include any suitable operating systems, such as IBM's zSeries/Operating System (z/05), MS-DOS, PC-DOS, MAC-OS (such as MAC OS X), WINDOWS, UNIX, OpenVMS®, LINUX®, SOLARIS, ADVANCED INTERACTIVE EXECUTIVE (AIX), HP-UX®, UBUNTU®, DEBIAN®, or any other appropriate operating systems, including future operating systems. Although FIG. 1 illustrates system 100 as including only three operating systems 178 (e.g., operating system 178a, operating system 178b, and operating system 178n), system 100 may include any number of operating systems 178.

Controller 180 represents any suitable set of instructions, logic, or code embodied in a computer readable storage medium and operable to control any number of probes 190. The present disclosure contemplates controller 180 being operable to control any aspect of probes 190. For example, controller 180 may control any suitable combination of: which probes 190 are installed on a host device 170 (such as by installing, re-installing, and/or uninstalling particular probes 190 on a host device 170); when probes 190 access and/or monitor information associated with a host device 170; the type of information that probes 190 monitor for; any transmission of the accessed and/or monitored information over network 150 (such as when a transmission may occur and what information may be included in a transmission); and any other aspect associated with probes 190. In certain embodiments, controller 180 may control any aspect regarding the monitoring of information associated with host devices 170. Controller 180 also may access (and/or provide access to) any discovery information associated with a host device 170 and/or communicate any discovery information associated with a host device 170 to any component of system 100, such as monitoring system 110.

Probes 190 may be operable to monitor information associated with host devices 170. Probes 190 may be implemented using any suitable combination of hardware, firmware, and software. In certain embodiments, probes 190 may represent any suitable set of instructions, logic, or code embodied in a computer readable storage medium.

Each probe 190 may perform a particular operation associated with monitoring information. For example, a first probe 190 may monitor for a first metric (e.g., first type of information), while a second probe 190 (and any other subsequent probes 190) may monitor different metrics (e.g., different types of information). Additionally, or alternatively, a single probe 190 may perform multiple operations and/or may monitor multiple types of metrics.

The types of metrics that a probe 190 may monitor may include any suitable combination of: (1) network-based metrics; (2) application-based metrics; (3) virtualization-based metrics; (4) storage-based metrics; (5) cloud-based metrics; (6) quality of service metrics; (7) server-based metrics; (8) bandwidth metrics; (9) website-based metrics; and (10) any other suitable type of metric. As an example, a probe 190 may monitor metrics regarding applications installed on host devices 170 (such as what applications are installed, what applications are currently running, what applications have expired service contracts, etc.), metrics regarding any host device 170 and/or any other devices connected to one or more networks (such as the Internet Protocol (IP) address of any host device, the Media Access Control (MAC) address of any host device, the user of a host device, etc.), metrics regarding virtualization associated with a host device 170 (such as how much processing power is being utilized by a host device 170, how much processing power is unused, etc.), metrics regarding storage associated with a host device 170 (such as how much storage is currently being used, how much storage is not being used, the type of storage (e.g., RAM, ROM, etc.), etc.), metrics regarding cloud computing associated with a host device 170 (such as what host devices 170 are implemented in cloud computing, the cost associated with cloud computing, etc.), any other metrics associated with a host device 170, or any combination of the preceding.

The present disclosure contemplates each probe 190 being able to monitor any metric associated with any component of network 150, such as any metric associated with any host device 170. For example, in addition to monitoring a metric associated with host device 170a, probe 190a may monitor a metric associated with host devices 170b and/or 170n, such as a metric regarding usage in host devices 170b and/or 170n, processing capabilities in host devices 170b and/or 170n, applications installed in host devices 170b and/or 170n, or any other metric.

In certain embodiments, probes 190 may monitor for alarms associated with host devices 170. As an example, one or more thresholds may be established for host device 170 (such as a threshold of 80% processor usage), and when those thresholds are reached (or exceeded), an alarm may be generated, which may be detected and/or generated by probes 190. Probes 190 may monitor information regarding alarms (and/or thresholds) associated with a host device 170 (such as what types of alarms are being monitored for, what alarms have been generated, how long an alarm has been generated for, etc.). As another example, probes 190 may monitor for usage information of controllers 180 and probes 190. In such an example, as controllers 180 and probes 190 are used to monitor information, their usage may be monitored and stored.

Although FIG. 1 is illustrated as only including two probes 190 installed on a particular host device 170 (e.g., two probes 190a installed on host device 170a and two probes 190b installed on host device 170b), any number of probes 190 may be installed on a host device 170. For example, a host device 170 may include no probes 190, a single probe 190, ten probes 190, one hundred probes 190, one thousand probes 190, or any other number of probes 190. In certain embodiments, a host device 170 may include a one-to-one ratio of controllers 180 and probes 190. For example, a host device 170 may include a single controller 180 and single probe 190, two controllers 180 and two probes 190, three controllers 180 and three probes 190, and so on.

Furthermore, although FIG. 1 is illustrated as only including three host devices 170 (e.g., host device 170a, host device 170b, and host device 170n), any number of host devices 170 may be included in system 100. For example, system 100 may include a single host device 170, ten host devices 170, one hundred host devices 170, one thousand host devices 170, or any other number of host devices 170. Additionally, although host device 170 has been described above as including a controller 180 and probes 190, in certain embodiments, one or more host devices 170 may not include either a controller 180 and/or probes 190. For example, as is illustrated in FIG. 1, host device 170n may not include either a controller 180 or any probes 190. Instead, if appropriate, one or more probes 190 installed on another host device 170 (such as host device 170a) may monitor information associated with host device 170n, in certain embodiments. As such, probes 190 may be able to monitor any type of information associated with host device 170n (such as information regarding memory usage in host device 170n, processing capabilities in host device 170n, applications installed in host device 170n, or any other information) without probes 190 (or a controller 180) being installed on host device 170n.

Hub 160 represents any component operable to control any aspect of controller 180, and may be implemented using any suitable combination of hardware, firmware, and software. For example, hub 160 may: control which controller 180 is installed on a host device 170 (such as by installing, re-installing, and/or uninstalling a particular controller 180 on a host device 170); control transmission of the monitored information over network 150 (such as when a transmission may occur and what information may be included in a transmission); control any other aspect associated with controller 180; provide instructions to controller 180 (such as instructions regarding what discovery information to access, what probes 190 to install, what information a probe 190 should access and/or monitor for, or any other instructions); or any combination of the preceding. Hub 160 may also be operable to link controllers 180 to each other. For example, hub 160 may allow a first controller 180 (such as controller 180a) to communicate with and/or coordinate with any other controller (such as controller 180b).

Hubs 160 may include any suitable type of computer system, such as a network server, any remote server, a mainframe, a workstation, a web space server, a personal computer, a file server, a virtual device, or any other device that may control controllers 180 and/or link controllers 180 of various host devices 170 to each other. The functions of each hub 160 may be performed by any combination of one or more servers or other components at one or more locations. In the embodiment where the module is a server, the server may be a private server, and the server may be a virtual or physical server. The server may include one or more servers at the same or remote locations. Also, hub 160 may include any component that functions as a server. Hub 160 may represent any suitable set of instructions, logic, or code embodied in a computer readable storage medium and operable to perform the described functions. As another example, hub 160 may be a particular type of controller (such as, for example, a controller 180) that may utilize (and/or control) one or more particular types of probes (such as, for example, probes 190) to access discovery information and/or monitor information associated with any host device 170 of network 150.

In certain embodiments, hubs 160 generally facilitate gathering discovery information associated with devices of network 150. For example, as described above, a hub 160 may access (and/or provide access to) any discovery information associated with a host device 170 and communicate it to any component of system 100, such as monitoring system 110. In certain embodiments, the discovery information is used to determine a metric associated with a host device 170 to be monitored.

Although FIG. 1 illustrates hub 160 as being a separate component from the other components of FIG. 1, in certain embodiments, hub 160 may be integrated with any of the other components of FIG. 1. As an example, hub 160a may be integrated with a host device 170, such as host device 170a. In such an example, instructions, logic, or code associated with hub 160a may be stored in memory 176a of host device 170a. This may allow host device 170a (and processor 174a) to perform one or more functions of hub 160a (in addition to one or more functions of controller 180a).

Network 150 represents any network operable to facilitate communication between various components of system 100, such as host devices 170, hubs 160, user device 142, and information database 154. Network 150 may include any interconnecting system capable of transmitting audio, video, signals, data, messages, or any combination of the preceding. Network 150 may include all or a portion of a public switched telephone network (PSTN), a public or private data network, a LAN, a MAN, a WAN, a local, regional, or global communication or computer network such as the Internet, a wireline or wireless network, an enterprise intranet, or any other suitable communication link, including combinations thereof, operable to facilitate communication between the components.

Central hub 140 represents any component operable to link (though not necessarily physically) hubs 160 (and/or controllers 180) to each other, and may be implemented using any suitable combination of hardware, firmware, and software. For example, central hub 140 may allow a first hub 160 (such as hub 160a) to communicate with and/or coordinate with any other hub 160 (such as hub 160b and/or hub 160n). Central hub 140 may include any suitable type of computer system, such as a network server, any remote server, a mainframe, a workstation, a web space server, a personal computer, a file server, a virtual device, or any other device that may link hubs 160 to each other. The functions of central hub 140 may be performed by any combination of one or more servers or other components at one or more locations. In the embodiment where the module is a server, the server may be a private server, and the server may be a virtual or physical server. The server may include one or more servers at the same or remote locations. Also, central hub 140 may include any component that functions as a server.

Central hub 140 may represent any suitable set of instructions, logic, or code embodied in a computer readable storage medium and operable to link hubs 160 to each other, in certain embodiments. As an example, central hub 140 may be a particular type of hub (such as, for example, a hub 160) and/or a particular type of controller (such as, for example, a controller 180) that may utilize (and/or control) one or more particular types of probes (such as, for example, probes 190) to link hubs 160 and/or controllers 180 to each other.

Central hub 140 may also provide access control, in certain embodiments. For example, central hub 140 may determine whether a first hub 160 (such as hub 160a) is allowed to access (e.g., communicate with, coordinate with, discover information associated with, etc.) another hub 160 (such as hub 160b) based on a permission level of the first hub 160 and/or the other hub 160. If the first hub 160 does not have the correct permission level to communicate with the other hub 160, central hub 140 may prevent the first hub 160 from doing so. Additionally, such access control provided by central hub 140 may be further applicable to host devices 170 and probes 190, thereby allowing or preventing access to host devices 170 and/or probes 190 (in addition to controllers 180). For example, central hub 140 may prevent a first probe 190 (such as one of probes 190a) from accessing another host device 170 and/or another probe 190 if the first probe 190 does not have the correct permission level.

Central hub 140 may further link the devices of network 150 to the devices of network 130, such as monitoring system 110. For example, central hub 140 may be an access point through which communication may pass from monitoring system 110 to one or more devices of network 150 (or vice versa). In such an example, central hub 140 may allow monitoring system 110 to access discovery information associated with any device of network 150. Central hub 140 also may allow one or more probes 190 to be downloaded (or otherwise communicated) from monitoring system 110 to a host device 170 for installation. Furthermore, by acting as an access point through which communication may pass from monitoring system 110 to one or more devices of network 150, central hub 140 may provide security for network 150.

Although FIG. 1 illustrates central hub 140 as being a separate component from the other components of FIG. 1, in certain embodiments, central hub 140 may be integrated with any of the other components of FIG. 1. As an example, central hub 140 may be integrated with a hub 160 (such as hub 160a) and/or a host device 170 (such as host device 170a). In such an example, instructions, logic, or code associated with central hub 140 may be stored in a memory of hub 160a and/or memory 176a of host device 170a. This may allow hub 160a and/or host device 170a (and processor 174a) to perform one or more functions of central hub 140 (in addition to one or more functions of controller 180a). Furthermore, while FIG. 1 illustrates only a single central hub 140 connecting network 130 to network 150, in certain embodiments, any suitable number of central hubs 140 may connect network 130 to network 150. For example, two central hubs 140 may connect network 130 to network 150, three central hubs 140 may connect network 130 to network 150, ten central hubs 140 may connect network 130 to network 150, or any other number of central hubs 140 may connect network 130 to network 150.

Additionally, although system 100 is illustrated as including only one central hub 140 and one network 130, in certain embodiments, system 100 may include any other number of central hubs 140 and networks 130. For example, system 100 may include two central hubs 140 and two networks 130, three central hubs 140 and three networks 130, ten central hubs 140 and ten networks 130, or any other number of central hubs 140 and any other number of networks 130.

User device 142 represents any components (hardware and/or software) that may display information to a user 146. User device 142 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 100 in order to display information to user 146. User device 142 may further allow user 146 to request information from host devices 170, controllers 180, and/or probes 190. For example, user 146 may want to view a particular type of information. User 146 may communicate such a request (using user device 142) to a hub 160 (such as hub 160a), causing a probe 190 (such as probe 190a) to monitor for, and provide such information for view by user 146. For example, probe 190 may to user 146 comprehensive monitoring information such as availability, performance, detailed network flow analysis, capacity, bandwidth utilization, application response metrics, and so on, via user device 142. User device 142 may comprise a user interface, such as a display, a microphone, keypad, or other appropriate terminal equipment usable by user 146.

Graphical user interface (GUI) 144 may display any information monitored by probes 190. For example, if user 146 requests information regarding devices connected to network 150, GUI 144 may display a list of such devices, the IP address of each of the devices, the type of operating system 178 of those devices, the type and number of probes 190 installed on the devices, or any combination of the preceding. As another example, if user 146 requests information regarding alarms associated with the monitored information, GUI 144 may display each of the alarms that have been generated, how many times those alarms have been generated, the devices those alarms are associated with, the probes associated with those alarms, or any combination of the preceding. GUI 144 may display the monitored information in real time or near real time (e.g., real time plus the time associated with monitoring, communicating, and formatting the information). In such an example, user 146 may request the monitored information directly from probes 190, and the monitored information may be provided in real time or near real time. GUI 144 may further display historical (or non-real time) monitored information. In such an example, user 146 may request the monitored information from information database 154, and the monitored information may be provided. GUI 144 may display the monitored information in any configuration. Furthermore, GUI 144 may be configured by the user in any manner to display the monitored information.

Information database 154 represents any components that may store information monitored by probes 190. For example, information database 154 may store information monitored by probes 190 and communicated to information database 154 for storage. Information database 154 may include a network server, any remote server, a mainframe, a host computer, a workstation, a web space server, a personal computer, a file server, a virtual device, or any other device that may store information monitored by probes 190. The functions of information database 154 may be performed by any combination of one or more servers or other components at one or more locations. In the embodiment where the module is a server, the server may be a private server, and the server may be a virtual or physical server. The server may include one or more servers at the same or remote locations. In addition to storing information monitored by probes 190, information database 154 may further provide the information for view by a user, such as user 146. For example, user 146 may send a message to information database 154 that requests particular information from information database 154. As such, information database 154 may gather such information and communicate it for view by user 146 on user device 142. Furthermore, although system 100 illustrates information database 154 as being connected to network 150, in certain embodiments, information database 154 may be connected to network 130.

Monitoring system 110, central hub 140, and/or any other components of system 100 may be communicatively coupled by network 130. In certain embodiments, network 130 may refer to any interconnecting system capable of transmitting audio, video, signals, data, messages or any combination of the preceding. Network 130 may include all or a portion of a public switched telephone network (PSTN), a public or private data network, a LAN, a MAN, a WAN, a local, regional, or global communication or computer network such as the Internet, a wireline or wireless network, an enterprise intranet, or any other suitable communication link, including combinations thereof, operable to facilitate communication between various components of system 100. Although FIG. 1 illustrates network 130 as being a separate network from network 150, in certain embodiments, network 130 and network 150 may both be the same network.

Monitoring system 110 represents any components that may communicate with central hub 140, hubs 160, host devices 170, and/or any other devices connected to network 150, and may be implemented using any suitable combination of hardware, firmware, and software. Monitoring system 110 may include a network server, any remote server, a mainframe, a host computer, a workstation, a web space server, a personal computer, a file server, a virtual device, or any other device that may communicate with the devices connected to network 150. In certain embodiments, monitoring system 110 includes a network interface 112, processor 114, input 116, output 118, and memory 120. The functions of monitoring system 110 may be performed in any combination of one or more servers or other components at one or more locations. In the embodiment where the module is a server, the server may be a private server, and the server may be a virtual or physical server. The server may include one or more servers at the same or remote locations.

In general, monitoring system 110 facilitates discovering monitorable information associated with host devices 170 and installing probes 190 configured to monitor that information on those devices. Monitoring system 110 may communicate instructions and/or commands to central hub 140, hubs 160, host devices 170, controllers 180, and/or any other devices connected to network 150. For example, monitoring system 110 may instruct discovery agents to access and provide discovery information associated with host devices 170 to monitoring system 110. In response to receiving discovery information, monitoring system 110 may determine metrics associated with a host device 170 to be monitored. Monitoring system 110 may then configure probes 190 to monitor those metrics and communicate the configured probes 190 to host device 170 for installation.

In certain embodiments, monitoring system 110 may further configure and store packages associated with the monitoring of information. For example, monitoring system 110 may store, in one or more databases of memory 120, installation packages 126 that include the instructions, logic, or code associated with central hub 140, hubs 160, controllers 180, and probes 190. Each installation package 126 may further include a probe 190 configured to monitor a particular metric. In such an example, installation packages 126 may be downloaded (or otherwise communicated) from monitoring system 110 for installation on one or more devices (such as, for example, host device 170a) of network 150.

In certain embodiments, monitoring system 110 may store usage information associated with network 150. For example, in response to the use of hubs 160, controllers 180, and/or probes 190 in network 150, information associated with that usage (e.g., the amount of such usage, what host devices 170 the usage occurred on, etc.) may be communicated to monitoring system 110 (from host devices 170 and/or hubs 160) for storage and/or processing. This usage information may allow monitoring system 110 to modify packages associated with the monitoring of information on host devices 170. In certain embodiments, this usage information also may allow monitoring system 110 to calculate a bill associated with the usage. The bill may represent the cost associated with the use of hubs 160, controllers 180, and probes 190 to monitor information associated with host devices 170.

Memory 120 may refer to any suitable device capable of storing and facilitating retrieval of data and/or instructions. Examples of memory 120 include computer memory (for example, RAM or ROM), mass storage media (for example, a hard disk), removable storage media (for example, a CD or a DVD), database and/or network storage (for example, a server), and/or any other volatile or non-volatile, non-transitory computer-readable memory devices that store one or more files, lists, tables, or other arrangements of information. Although FIG. 1 illustrates memory 120 as internal to monitoring system 110, it should be understood that memory 120 may be internal or external to monitoring system 110, depending on certain implementations. Also, memory 120 may be separate from or integral to other memory devices to achieve any suitable arrangement of memory devices for use in system 100.

Memory 120 is generally operable to store a central discovery engine (CDE) 122, policies 123, automatic configuration engine (ACE) 124, rules 125, and installation package 126. CDE 122 and ACE 124 generally refer to logic, rules, algorithms, code, tables, and/or other suitable instructions for performing the described functions and operations. In certain embodiments, CDE 122 facilitates gathering discovery information associated with host devices 170. In certain embodiments, ACE 124 facilitates configuring and communicating installation packages 126 to host devices 170.

Memory 120 communicatively couples to processor 114. Processor 114 is generally operable to execute CDE 122 and ACE 124 stored in memory 120 to monitor information in network 150 according to this disclosure. Processor 114 may comprise any suitable combination of hardware and software implemented in one or more modules to execute instructions and manipulate data to perform the described functions for monitoring system 110. In some embodiments, processor 114 may include, for example, one or more computers, one or more central processing units (CPUs), one or more microprocessors, one or more applications, and/or other logic.

In certain embodiments, network interface 112 is communicatively coupled to processor 114 and may refer to any suitable device operable to receive input for monitoring system 110, send output from monitoring system 110, perform suitable processing of the input or output or both, communicate to other devices, or any combination of the preceding. Network interface 112 may include appropriate hardware (e.g., modem, network, interface card, etc.) and software, including protocol conversion and data processing capabilities, to communicate through network 130 or another communication system (e.g., network 150), which allows monitoring system 110 to communicate to other devices. Network interface 112 may include any suitable software operable to access data from or transmit data to various devices such as central hub 140, user device 150, information database 154, hubs 160, and/or host devices 170. Network interface 112 may also include one or more ports, conversion software, or both. In general, network interface 112 receives discovery information associated with host devices 170 and communicates installation packages 126 to host devices 170.

In certain embodiments, input device 116 may refer to any suitable device operable to input, select, and/or manipulate various data and information. Input device 116 may include, for example, a keyboard, mouse, graphics table, joystick, light pen, microphone, scanner, or other suitable input device. Output device 118 may refer to any suitable device operable for displaying information to a user. Output device 118 may include, for example, a video display, a printer, a plotter, or other suitable output device.

In operation, CDE 122, upon execution by processor 114, facilitates gathering discovery information associated with one or more components of network 150 that may be used to determine monitorable information (and/or utilized for installing an installation package 126 in a host device 170). CDE 122 may first receive a request to monitor a host device 170. In response to the request, CDE 122 may access a first set of discovery information associated with host device 170. The first set of discovery information may indicate at least one characteristic of a host device 170. For example, first set of discovery information may include the address of host device 170 (such as the IP address) in which installation is requested, a type of operating system installed on host device 170 (such as Red Hat LINUX), a network protocol for communicating with host device 170 (such as the Secure Copy protocol (SCP)), information associated with the architecture of host device 170 (such as whether the host device has a CPU architecture of 32 bits, 64 bits, or any other number of bits), host device 170 configuration parameters (such as a selection of what hub and/or what network the host device should be connect to), any other information, or any combination of the preceding.

CDE 122 may then determine, based on the first set of discovery information, a second set of discovery information associated with host device 170. The second set of discovery information may include any information associated with host device 170 that may be monitorable and, in certain embodiments, may refer to more detailed characteristics of host device 170. For example, the second set of discovery information may comprise network-based information (e.g., the Internet Protocol (IP) address of any host device, the Media Access Control (MAC) address of any host device of network 150, the user of a host device 170, etc.), application-based information (such as what applications are installed, what applications are currently running, what applications have expired service contracts, etc.), virtualization-based information (e.g., how much processing power is being utilized by a host device 170, how much processing power is unused, etc.), storage-based information (e.g., how much storage is currently being used, how much storage is not being used, the type of storage (e.g., RAM, ROM, etc.), etc.), cloud-based information (e.g., what host devices 170 are implemented in cloud computing, the cost associated with cloud computing, etc.), server-based information (e.g., what tasks the server performs, what components of system 100 the server of host device 170 communicates with, etc.), quality of service information (e.g. information about the end user's experience), bandwidth-based information (e.g., information about the maximum throughput of network 150, the rate of successful data transfers, etc.), architecture-based information, website-based information, database information, or any combination of the preceding.

Any aspect of the second set of discovery information may also be utilized for automatically configuring probes and installing an installation package 126 comprising the configured probes in a host device 170. In certain embodiments, the second set of discovery information may also include information indicating whether a version of a controller 180 operable to configure probes 190 is already installed on a host device 170. Moreover, characteristics of the first and second sets of discovery information may overlap, in certain embodiments.

In certain embodiments, the first set of discovery information may be processed according to one or more pre-defined policies 123 to determine the second set of discovery information. For example, CDE 122 may determine a pre-defined policy 123 that corresponds to a characteristic indicated by the first set of discovery information, and based on the pre-defined policy 123 (in addition to the first set of discovery information), determine a second set of discovery information associated with host device 170.

Examples of a pre-defined policies 123 may include: (1) if major_os=WINDOWS then determine number and letter of attached hard drives; (2) if major_os=WINDOWS AND virtual_server_ip matches discovered_ip then run secondary discovery on virtual server to determine disk farm mapping; (3) for physical servers associated with a host device 170 (or any other component of network 150), perform a port scan and protocol scan on known service ports (such as port 3306 for MySQL (My Structured Query Language) database server or 8080 for J2EEv (JAVA 2 Platform Enterprise Edition) web application container), and if responsive, discover secondary service using specific discovery engine. Although particular examples of pre-defined policies 123 have been described, this disclosure contemplates any suitable pre-defined policies 123, according to particular needs.

After determining the second set of discovery information, CDE 122 may utilize central hub 140, hubs 160, controllers 180, and/or probes 190 to access the second set of discovery information. As an example, CDE 122 may command central hub 140, hubs 160, controllers 180, and/or probes 190 to: perform a port scan and/or ping sweep of host device 170; measure one or more metrics associated with any component of network 150 (e.g., CDE 122 may instruct and deploy an existing probe of a first host device to measure a metric associated with any other host devices of a network); analyze routing tables of host device 170; determine communication paths between physical servers associated with host device 170; search for specific services associated with host device 170 (e.g., a shopping cart service or inventory management service); or perform any other suitable operation to access the second set of discovery information. The first and second sets of discovery information may then be communicated to ACE 124 for processing.

In operation, ACE 124, upon execution by processor 114, facilitates determining a metric associated with host device 170 to be monitored, configuring probe 190 to monitor the particular metric, and communicating an installation package 126 comprising configured probe 190 to host device 170. Probe 190 may be configured to monitor any type of metric, such as a network-based metric, application-based metric, virtualization-based metric, storage-based metric, usage-based metric, cloud-based metric, quality of service metric, server-based metric, bandwidth metric, website-based metric, and any other suitable type of metric. In certain embodiments, a single probe 190 may be configured to monitor multiple metrics associated with a host device 170 (e.g., probe 190 may be configured to monitor both an application-based metric and server-based metric). In certain embodiments, the metrics to be monitored may be related to the second set of discovery information.

In the illustrated embodiment, ACE 124 may process the first and second sets of discovery information according to a set of pre-defined rules 125 to determine one or more metrics associated with host device 170 to be monitored. Examples of pre-defined rules 125 may include: (1) if a host device 170 (or any other component of network 150) is a virtual device, then apply VMware (Virtual Machine software) probe to gather metrics using Simple Network Management Protocol (SNMP); (2) if an operating system 178 of a host device 170 (or any other component of network 150) is a version of WINDOWS, then use WINDOWS Management Instrumentation (WMI) protocol to discover any contained monitorable entities and install a CDM (e.g., CPU, disk, and memory) probe to monitor those contained monitorable entities; (3) if a server associated with a host device 170 (or any other component of network 150) is a WINDOWS server and is a HTTP web server, then install a web server monitoring probe with default metric availability; (4) based on one or more attributes of the first and second sets of discovery information, access a third set of discovery information associated with a host device 170; (5) process the first and second sets of discovery information according to a set of matching filters to determine whether one or more attributes of the first and second sets of discovery information correspond to a set of actions (e.g., actions to determine further discovery information or to instantiate intelligent, appropriate probing), and if so, taking the appropriate action (e.g., if major_os=WINDOWS Server, then determine hardware manifest using WMI probing); and (6) based on one or more attributes of the first and second sets of discovery information, determine to apply a database probe with default metrics. Although particular examples of pre-defined rules 125 have been described, this disclosure contemplates any suitable pre-defined rules 125, according to particular needs.

In response to determining a metric to be monitored, ACE 124 may generate an installation package 126 comprising a probe 190 configured to monitor the metric and communicate installation package 126 to host device 170. In certain embodiments, installation package 126 may be communicated to other components of network 150, such as central hub 140, hubs 160, and controllers 180. Installation package 126 may include instructions, logic, or code associated with the particular probe 190 (such as probe 190a) or any other component of system 100 (such as central hub 140, hubs 160, controllers 180, and other probes 190). In such an example, installation package 126 may be downloaded (or otherwise communicated) from monitoring system 110 for installation on one or more devices (such as host device 170a) of network 150.

In certain embodiments, ACE 124 (in addition to central hub 140, hubs 160, or controllers 180) may communicate a command to host device 170 to cause host device 170 to install installation package 126. Installing installation package 126 may include reconfiguring, reinstalling, or uninstalling an existing probe on host device 170 and/or installing and configuring a new probe on host device 170. In certain embodiments, ACE 124 may determine whether the installation of installation package 126 was successful. For example, ACE 124 may communicate a command to a discovery agent requesting the discovery agent to provide information indicating whether the installation of installation package 126 was successful.

In an example embodiment of operations, a user 146 may want to monitor information associated with one or more devices of a network, such as network 150. User 146 may also want to view such monitored information. Thus, a central hub 140 and one or more hubs 160 may be installed in network 150, and one or more controllers 180 may be installed in one or more host devices 170 of network 150. The installation of central hub 140, hubs 160, and controllers 180 may occur in any suitable manner. For example, instructions, logic, or code associated with central hub 140, hubs 160, and/or controllers 180 may be downloaded from monitoring system 110 and installed in network 150 (such as installed on host device 170). After central hub 140, hubs 160, and/or controllers 180 have been installed on host devices 170, system 100 facilitates automatically discovering monitorable information associated with host devices 170 and installing probes 190 configured to monitor that information on those devices by performing the above-described functions and operations.

Once probes 190 are installed on host devices 170, probes 190 may monitor information associated with the host devices 170. This monitored information may be communicated to information database 154 for storage and/or to monitoring system 110 for processing. In response to the monitored information, monitoring system 110 may request that a probe 190 be configured to monitor particular information associated with host devices 170. The probe 190 may be a probe already installed on a host device 170 or a new probe to be installed on the host device 170. In certain embodiments, a user 146 may utilize user device 142 to request stored monitored information for viewing on graphical user interface (GUI) 144. The monitored information may also be communicated directly to user device 142 for display in GUI 144. Additionally, user 146 may request that a probe 190 monitor particular information associated with host devices 170 (e.g., the unused memory in host device 170n). In response to this request, probe 190 may monitor the requested information and send it to user 146 via user device 142 for view in GUI 144 in real time (or near real time). Thus, user 146 may be able to view and understand any monitorable aspects of the network and/or devices operating in the network.

Moreover, in response to utilization of controllers 180 and/or probes 190, usage information may be monitored (e.g., by one of the probes 190) and communicated to monitoring system 110. This usage information may be used by monitoring system 110 to calculate a bill associated with the use of controllers 180 and probes 190. Furthermore, this bill may be communicated to user 146 (or any other entity associated with user device 142) for payment.

Modifications, additions, or omissions may be made to system 100 without departing from the scope of the disclosure. Additionally, system 100 may include any number of host devices 170, networks 150, user devices 142, information databases 154, networks 130, and/or monitoring systems 110. Furthermore, any suitable logic may perform the functions of system 100 and the components within system 100.

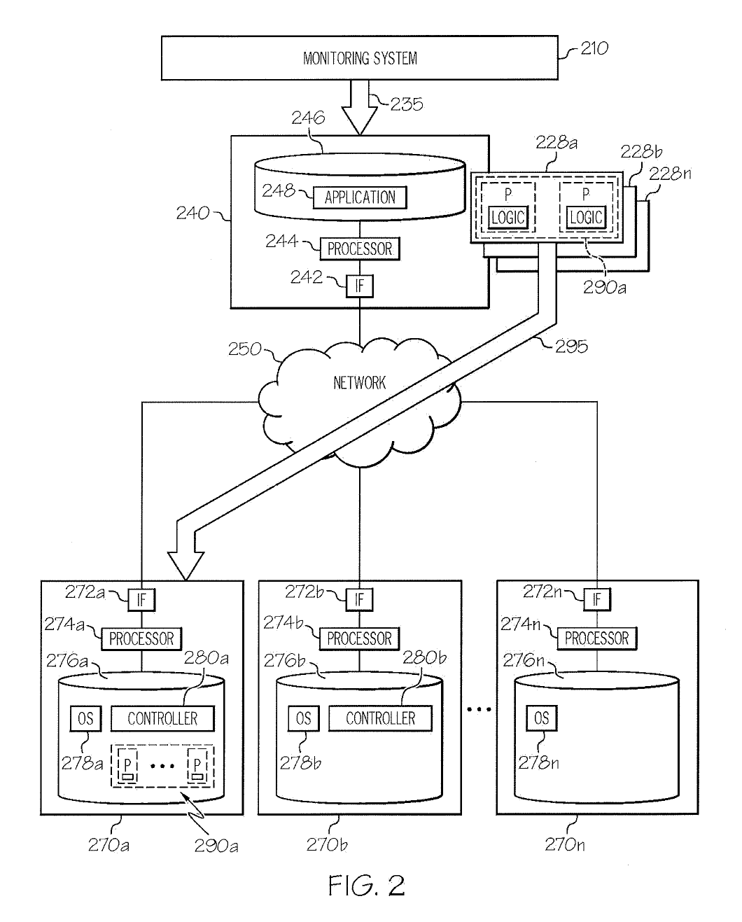

FIG. 2 illustrates another example of a system 200 for installing and configuring a probe in a distributed computing environment according to one embodiment of the present disclosure. Such an automatic configuration and installation may allow a first installation package 228 to be automatically installed on a first host device 270 (such as host device 270a) that includes a first operating system 278a and a first controller 280a. Furthermore, the automatic configuration and installation may further allow a second installation package 228 to be automatically installed on a second host device (such as host device 270b or host device 270n) that includes another operating system 278b and a second controller 280b. Thus, in certain embodiments, an automatic configuration and installation of installation packages 228 may be implemented, no matter what operating system 278 is installed on a host device 270.

According to the illustrated embodiment, system 200 includes a monitoring system 210, hub 240, network 250, and host devices 270. Hub 240 represents any components (hardware and/or software) for linking controllers 280 to each other. Hub 240 of FIG. 2 may be substantially similar to central hub 140 and/or hubs 160 of FIG. 1. In the illustrated embodiment, hub 240 includes a network interface 242, processor 244, and memory 246.

Network interface 242 represents any component operable to receive information from network 250 (or network 150 of FIG. 1), transmit information through network 250 (or network 150 of FIG. 1), perform processing of information, communicate to other devices, or any combination of the preceding, and may be implemented using any suitable combination of hardware, firmware, and software. For example, network interface 242 may receive information from user device 242. As another example, network interface 242 may communicate installation packages 228 to host devices 270. Network interface 242 represents any port or connection, real or virtual, including any suitable hardware and/or software, including protocol conversion and data processing capabilities, to communicate through a LAN, a MAN, a WAN, or other communication system that allows hub 240 to exchange information with network 250, host devices 270, or other components of system 200.

Processor 244 communicatively couples to network interface 242 and memory 246, and controls the operation and administration of hub 240 by processing information received from network interface 242 and memory 246. For example, processor 244 executes application 248 to control the operation of hub 240. Processor 244 may be a programmable logic device, a microcontroller, a microprocessor, any processing device, or any combination of the preceding.

Memory 246 stores, either permanently or temporarily, data, operational software, or other information for processor 244. Memory 246 includes any one or a combination of volatile or non-volatile, local or remote devices suitable for storing information. For example, memory 246 may include RAM, ROM, magnetic storage devices, optical storage devices, or any other information storage device or a combination of these devices. While illustrated as including a particular module, memory 246 may include any information for use in the operation of hub 240. In the illustrated embodiment, memory 246 includes application 248. Application 248 represents any suitable set of instructions, logic, or code embodied in a computer readable storage medium and operable to facilitate the operation of hub 240. As an example, application 248 may be a particular type of controller (such as, for example, a controller 180 of FIG. 1) that may utilize (and/or control) one or more particular types of probes (such as, for example, probes 190 of FIG. 1) to facilitate the operation of hub 240. Furthermore, application 248 is further operable to implement an automatic configuration and installation of installation packages 228 on host devices 270, as is described below in further detail.

System 100 further includes host devices 270, network 250, and monitoring system 210. A host device 270 of FIG. 2 (which includes network interface 272, processor 274, memory 276, and operating system 278) may be substantially similar to host device 170 of FIG. 1 (which includes network interface 172, processor 174, memory 176, and operating system 178). Network 250 of FIG. 2 may be substantially similar to network 150 of FIG. 1. Monitoring system 210 of FIG. 2 may be substantially similar to monitoring system 110 of FIG. 1.

In an example embodiment of operations, a user (such as user 146 of FIG. 1) may want to monitor information associated with one or more host devices 270. In order for such monitoring to occur, the user may want probes 290 (such as probes 290a) to be automatically configured and installed on host devices 270 (such as host device 270a). A user (or some other entity, including automated entities) may communicate a request to monitor host devices 270. As described above with regard to FIG. 1, in response to the request, monitoring system 210 may determine metrics associated with host devices 270 to be monitored, configure probes 290 to monitor the metrics, and generate installation packages 228 (e.g., installation packages 228a, 228b, and 228n) comprising the configured probes 290 for host device 270s.

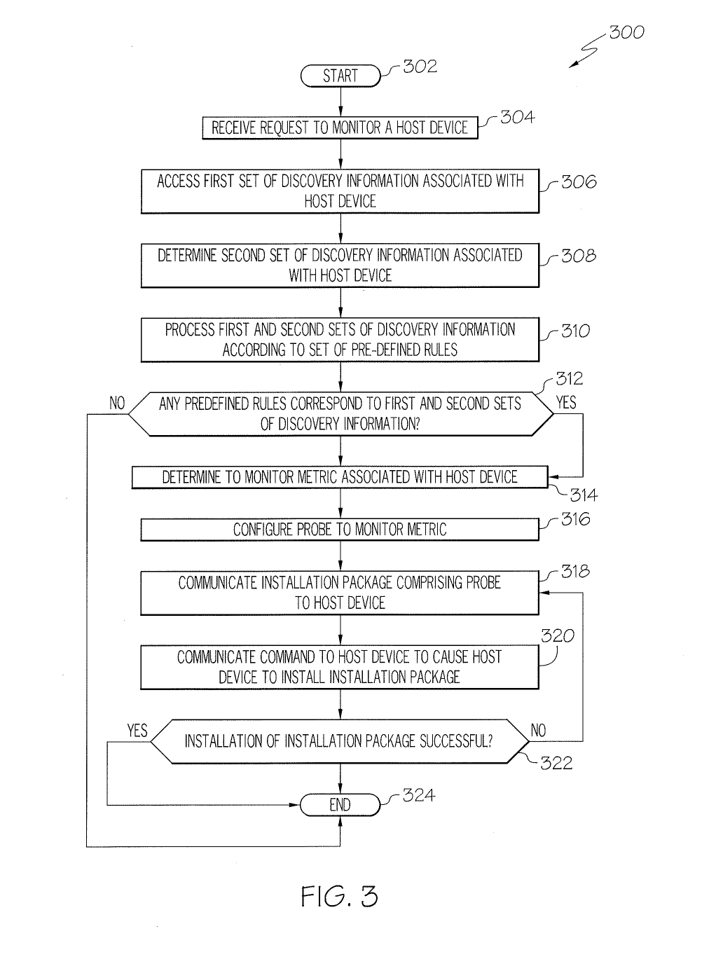

Once installation package 228 has been generated for a host device 270, monitoring system 210 may communicate a command 235 (in addition to installation package 228) to, for example, hub 240, to request installation of the configured probes 290 on a host device 270 (such as host device 270a). In response to receiving command 235, application 248 may create an installation instance 288 for the installation of configured probes 290. Application 248 may then utilize installation instance 288 (such as 288a) to communicate with a host device 270 (such as host device 270a) via installation message 295. This installation message 295 may be communicated in accordance with a network protocol for the host device 270 (as is described below with regard to FIG. 3). Installation message 295 may implement the installation of an installation package 228 (such as installation package 228a, which includes probes 290a) on a host device 270 (such as host device 270a). In particular, installation message 295 may communicate installation package 228 to host device 270, communicate a command to host device 270 to cause host device 270 to install installation package 228, and communicate a command to determine whether the installation of installation package 228 was successful. Additional details regarding the installation of an installation package 228 in a host device 270 are described below with regard to FIG. 3.

Modifications, additions, or omissions may be made to system 200 without departing from the scope of the invention. For example, hub 240 and one or more host devices 270 may be integrated. Additionally, system 200 may include any number of monitoring systems 210, hubs 240 (such as central hub 140 and hubs 160 of FIG. 1), networks 250, and/or host devices 270. Although FIG. 2 illustrates system 200 as including only three network interfaces 272 (e.g., network interface 272a, network interface 272b, and network interface 272n), three processors 274 (e.g., processor 274a, processor 274b, and processor 274n), three memories 276 (e.g., memory 276a, memory 276b, and memory 276n), and three operating systems 278 (e.g., operating system 278a, operating system 278b, and operating system 278n), system 200 may include any number of network interfaces 272, processors 274, memories 276, and operating systems 278.

Furthermore, system 200 may also include any number of components of system 100 of FIG. 1 (such as any number of networks 130, information databases 154, hubs 160, and/or user devices 142). Additionally, any suitable logic may perform the functions of system 200 and the components within system 200.

FIG. 3 illustrates an example of a method 300 for installing and configuring a probe in a distributed computing environment according to one embodiment of the present disclosure. In general, method 300 facilitates the automatic self-discovery and probing of networks (e.g., in a service provider network). In certain embodiments, one or more steps of method 300 may be performed by monitoring system 110 and/or discovery agents of FIG. 1; however, the present disclosure contemplates any suitable combination of components of system 100 performing one or more steps of method 300.

The method begins at step 302. At step 304, a request to monitor a host device 170 is received. The request may be received by monitoring system 110 from user device 142, in certain embodiments. Based on the received request, monitoring system 110 may utilize discovery agents to access a first set of discovery information associated with host device 170 at step 306. The first set of discovery information may indicate at least one characteristic of host device 170, such as a characteristic that may be utilized for installing an installation package 126 in a host device (in addition to being utilized to determine a second set of discovery information associated with a host device). For example, the first set of discovery information may include any suitable combination of: an address of a host device (such as the IP address) in which installation is requested, a type of operating system installed on the host device (such as Red Hat LINUX), information associated with the architecture of the host device (such as whether the host device has a CPU architecture of 32 bits, 64 bits, or any other number of bits), host device configuration parameters (such as a selection of what hub and/or what network the host device should be connect to), and any other installation information.

The first set of discovery information may include a network protocol of host device 170. The network protocol may represent any protocol (e.g., rules and conventions) for communicating with host device 170 over a network. As an example, a network protocol may include an application layer network protocol, such as Secure Copy (SCP), Secure Shell (SSH), Service Message Block (SMB), Windows Management Instrumentation (WMI), Hypertext Transfer Protocol (HTTP), Hypertext Transfer Protocol Secure (HTTPS), Extensible Messaging and Presence Protocol (XMPP), Dynamic Host Configuration Protocol (DHCP), or any other suitable application layer network protocol. In certain embodiments, the network protocol utilized for communicating with host device 170 may be based on the operating system installed on host device 170. For example, each host device of a network may have a different type of operating system (such as, for example, a version of LINUX (such as Red Hat LINUX), a version of WINDOWS, a version of SOLARIS, a version of AIX, a version of HP-UX, a version of MAC OS X, a version of UBUNTU, a version of DEBIAN, or any other type of operating system). In such an example, different network protocols may be utilized in order to communicate with host devices 170 with different operating systems.

The network protocol may be accessed in any suitable manner. For example, a discovery agent may include (and/or or have access to) mapping information that includes information regarding what network protocol may be utilized to communicate with a host device with a particular operating system. The mapping information may be stored as any suitable data structure that maps a network protocol to a host device 170 with a particular operating system. As examples, the mapping information may be stored as any suitable combination of one or more tables, databases, charts, lists, and any other suitable mapping structures. The mapping information may be utilized to access the network protocol for a host device with a particular operating system. For example, a discovery agent may utilize the identity of the type of operating system installed on host device 170 (such as Red Hat LINUX) in combination with the mapping information to determine that a particular network protocol (such as the file transfer protocol SCP and the remote command protocol SSH) should be used with that host device 170. Once the network protocol has been determined, the network protocol may be used to communicate with host device 170 and/or determine a second set of discovery associated with host device 170.

At step 308, a second set of discovery information associated with host device 170 may be determined by monitoring system 110 based on the first set of discovery information. In certain embodiments, monitoring system 110 may utilize discovery agents to access the second set of discovery information. The second set of discovery information may include any information associated with host device 170 that may be monitorable. For example, the second set of discovery information may include any suitable combination of network-based information, application-based information, virtualization-based information, storage-based information, cloud-based information, server-based information, quality of service information, architecture-based information, website-based information, database information, and any other suitable information. Any aspect of the second set of discovery information may be utilized for automatically configuring probes 190 and installing an installation package 126 comprising the configured probes 190 in a host device 170. In certain embodiments, the second set of discovery information may comprise installation information for other host devices of a network to be monitored. For example, when monitoring is requested on another fifteen host devices (in addition to host device 170), installation information may be gathered for each of the other fifteen host devices at step 308. This installation information may be substantially similar to one or more characteristics of the first and second sets of discovery information as described above.

In order to determine or otherwise access the second set of discovery information, one or more commands may be communicated to discovery agents and/or host device 170 (e.g., using the determined network protocol) to request from the discovery agents and/or host device 170 any characteristic of the second set of discovery information. The commands used to determine the second set of discovery information may include any suitable instructions, logic, or code that may ask the discovery agents and/or host device 170 to provide the second set of discovery information.

In certain embodiments, the first set of discovery information may be processed according to a set of pre-defined policies 123 (of FIG. 1) to determine the second set of discovery information. For example, it may be determined that a pre-defined policy 123 corresponds to a characteristic indicated by the first set of discovery information, and based on the pre-defined policy 123 (in addition to the first set of discovery information), a second set of discovery information associated with host device 170 may be determined.

Examples of pre-defined policies 123 may include: (1) if major_os=WINDOWS then determine number and letter of attached hard drives; (2) if major_os=WINDOWS AND virtual_server_ip matches discovered_ip then run secondary discovery on virtual server to determine disk farm mapping; (3) for physical servers associated with a host device 170 (or any other component of network 150), perform a port scan and protocol scan on known service ports (such as port 3306 for MySQL (My Structured Query Language) database server or 8080 for J2EE (JAVA 2 Platform Enterprise Edition) web application container), and if responsive, discover secondary service using specific discovery engine. Although particular examples of pre-defined policies 123 have been described, this disclosure contemplates any suitable pre-defined policies 123, according to particular needs.

At step 310, the first and second sets of discovery information may be processed according to a set of pre-defined rules 125 (of FIG. 1). The first and second sets of discovery information may be processed according to the set of pre-defined rules 125 to determine which rules may apply to the monitored host device 170. Examples of pre-defined rules 125 include: (1) if a host device 170 (or any other component of network 150) is a virtual device, then apply VMware (Virtual Machine software) probe to gather metrics using Simple Network Management Protocol (SNMP); (2) if an operating system 178 of a host device 170 (or any other component of network 150) is a version of WINDOWS, then use Windows Management Instrumentation (WMI) protocol to discover any contained monitorable entities and install a CDM (e.g., CPU, disk, and memory) probe to monitor those contained monitorable entities; (3) if a server associated with a host device 170 (or any other component of network 150) is a WINDOWS server and is a HTTP web server, then install a web server monitoring probe with default metric availability; (4) based on one or more attributes of the first and second sets of discovery information, access a third set of discovery information associated with a host device 170; (5) process the first and second sets of discovery information according to a set of matching filters to determine whether one or more attributes of the first and second sets of discovery information correspond to a set of actions (e.g., actions to determine further discovery information or to instantiate intelligent, appropriate probing), and if so, taking the appropriate action (e.g., if major_os=WINDOWS Server, then determine hardware manifest using WMI probing); and (6) based on one or more attributes of the first and second sets of discovery information, determine to apply a database probe with default metrics. Although particular examples of pre-defined rules 125 have been described, this disclosure contemplates any suitable pre-defined rules 125, according to particular needs.

The method may determine whether any pre-defined rules 125 correspond to the first and second sets of discovery information at step 312. If it is determined that the pre-defined rules do not correspond to the first and second sets of discovery information, the method may move to step 324, where the method ends. This decision to end method 300 may be based on a determination that host device 170 is not associated with monitorable information.

On the other hand, if the method determines that a pre-defined rule corresponds to the first and second sets of discovery information, at step 314, a metric associated with host device 170 to be monitored may be determined based on the corresponding pre-defined rule. In certain embodiments, multiple pre-defined rules may correspond to the first and second sets of discovery information. In such an example, the method may determine to monitor multiple metrics associated with host device 170.

At step 316, a probe 190 may be configured to monitor a metric associated with host device 170. Monitoring system 110 may configure probe 190 based on the metric determined to be monitored. Probe 190 may be configured to gather information associated with the metric for various purposes. For example, at least a portion of the monitored information may be provided for view by a user, at least a portion of the monitored information may be stored (such as for later use and/or for later reference), at least a portion of the monitored information may be processed, grouped, characterized, and/or summarized for view by a user, at least a portion of the monitored information may be compared to one or more thresholds, any other suitable use of the monitored information, or any suitable combination of the preceding.

Step 316 may further include generating (or configuring) an installation package 126 comprising the configured probe 190. In the example where the method determines multiple metrics to be monitored (as described above), any number of probes 190 may be configured to monitor the multiple metrics (e.g., a single probe 190 may be configured to monitor the multiple metrics, multiple probes 190 may each be configured to monitor one of the multiple metrics, etc.). Further, any number of installation packages 126 may be generated (or configured) to comprise any number of configured probes 190. For example, a single installation package 126 may be generated for all configured probes 190, an installation package 126 may be generated for each configured probe 190, and so on.

At step 318, installation package 126 may be communicated to host device 170. Installation package 126 may include any suitable instructions, logic, or code associated with installing and configuring a probe 190 on a host device 170. For example, installation package 126 may include any suitable combination of one or more probes 190, one or more probe configuration parameters (such as how a probe should be configured and how it should behave once it is installed), and any other suitable logic associated with installing and configuring probes on host device 170 (such as configuration parameters for a controller or hub associated with host device 170). Installation package 126 may be communicated to host device 170 based on the determined network protocol for host device 170. For example, installation package 126 may be communicated to host device 170 with the Red Hat LINUX operating system using, for example, the file transfer protocol SCP. Installation package 126 may be communicated from monitoring system 110 to host device 170 using installation message 295 of FIG. 2. In certain embodiments, installation package 126 may be communicated to any other component of a network (such as central hub 140, hubs 160, and controllers 180 of network 150 of FIG. 1).

Installation package 126 may be communicated to host device 170 in any suitable manner. For example, installation package 126 may be communicated to host device 170 by communicating one or more commands to cause host device 170 to copy installation package 126. The commands used to cause host device 170 to copy installation package 126 may include any suitable instructions, logic, or code. Examples of such commands may include “scp <answer file> <tempdir> && scp <rpm> <tempdir>”, “xcopy <answer file> <tempdir> && xcopy <msi> <tempdir>”, “robocopy <answer file> <tempdir> && robocopy <msi> <tempdir>”, any other suitable command, or any combination of the preceding.

In certain embodiments, prior to communicating installation package 126 to host device 170, step 318 may further include additional steps. For example, one or more pre-clean commands may be communicated to host device 170 to cause host device 170 to clean up one or more previous attempted installations of a probe 190. In such an example, a previous installation of a probe 190 may have been unsuccessful, resulting in a partial installation. The pre-clean commands may cause host device 170 to uninstall the previous installation (thereby preventing the previous installation from interfering with the new installation). The pre-clean commands may include any suitable instructions, logic, or code that cause host device 170 to uninstall the previous installation. Examples of such commands may include “del tempdir/*”, “rm tempdir/<packageName> && rm opt/robot-vars*.cfg”, “rm tempdir/<packageName> && rm opt/robot-vars*.cfg”, “rm tempdir/<packageName> && rm opt/robot-vars*.cfg”, “rm tempdir/<packageName> && rm opt/robot-vars*.cfg”, any other suitable command, or any combination of the preceding. The pre-clean commands may be communicated by a discovery agent and/or monitoring system 110 to host device 170 using installation messages 295.

At step 320, a command is communicated to host device 170 to cause host device 170 to install installation package 126. The command may include any suitable instructions, logic, or code that cause host device 170 to install installation package 126. Examples of such commands may include “msiexec/qn <msiName> --allusers=2”, “rpm -ivh <rpmPath>”, “gunzip PKG && pkgadd -d <pkgPath>”, “dpkg -I <debPath> && initctl start nimbus”, “dpkg -I <debPath> && /etc/init.d/nimbus start”, any other suitable command, or any combination of the preceding. Based on this command, host device 170 may install installation package 126 (resulting in the installation of one or more probes 190). In addition to causing host device 170 to install installation package 126, the command may further cause host device 170 to start controller 180 of host device 170. As such, the installed and configured probes 190 may then begin to monitor information associated with host device 170. The command may be communicated using the determined network protocol.

At step 322, monitoring system 110 may determine whether the installation of installation package 126 was successful. For example, one or more commands may be communicated to host device 170 in order to ask a probe 190 if it is alive. These commands may include any suitable instructions, logic, or code that ask probe 190 if it is alive, such as, for example, “Request to probe”, any other suitable command, or any combination of the preceding. If probe 190 responds to the commands, it may be determined that installation package 126 was installed successfully. As another example, one or more status messages may be communicated to host device 170 in order to determine whether probe 190 is alive. If probe 190 (or any other component of host device 170, such as controller 180) indicates that installation package 126 was installed successfully, it may be determined that installation package 126 was installed successfully. If installation package 126 is determined to not have been installed successfully, the method 300 may move back to step 318, where installation package 126 is re-communicated to host device 170. This subsequent communication may cause a subsequent installation of installation package 126. On the other hand, if installation package 126 is determined to have been installed successfully, the method may move to step 324, where the method ends.

Although FIG. 3 illustrates method 300 as ending at step 324, in certain embodiments, the method may not end. In particular, instead of method 300 ending, each of steps 304-322 may be repeated for each of host devices 170 for which installation was requested. For example, if installation was requested for, fifteen host devices, method 300 may be repeated for each of the remaining fourteen host devices. In addition to repeating the steps of method 300 for each of the devices for which installation was requested, in certain embodiments, one or more of the steps of method 300 for a particular host device may be performed in parallel (e.g., at the same time) or substantially parallel (e.g., the processor may perform a first step for a first host device and then subsequently perform that same step for the second host device before performing a second step for the first host device) with one or more steps of method 300 for another host device. For example, as seen in FIG. 2, multiple installation instances 288 may be created that may each run (and install installation packages 126) in parallel or substantially in parallel with each other. This may allow each of host devices to have the installation package installed at substantially the same time, as opposed to in sequence, in certain embodiments. On the other hand, in certain embodiments, one or more of the installation packages 126 may also be installed in sequence for one or more of the host devices.

Modifications, additions, or omissions may be made to method 300. Additionally, one or more steps in method 300 of FIG. 3 may be performed in parallel or in any suitable order. For example, steps 318 and 320 of method 300 may be performed in parallel.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
accessing, by a processor, in response to a request to monitor a host device, a first set of discovery information associated with the host device, the first set of discovery information indicating at least one characteristic of the host device;
determining, based on the first set of discovery information, a second set of discovery information associated with the host device;
determining, based on the first and second sets of discovery information and based on one or more pre-defined rules, a metric associated with the host device to be monitored; and
communicating, based on the metric to be monitored, an installation package to the host device, the installation package comprising a probe, the probe configured to monitor the metric.

2. The method of claim 1, wherein the first set of discovery information comprises one or more of:
a type of operating system installed on the host device;
a network protocol for communicating with the host device; and
a service running on the host device.

3. The method of claim 2, wherein the type of operating system installed on the host device comprises one or more of:
a version of Linux;
a version of Windows;
a version of Solaris;
a version of Advanced Interactive eXecutive;
a version of HP-UX; and
a version of MAC OS X.

4. The method of claim 1, wherein the second set of discovery information comprises one or more of:
network-based information;
application-based information;
virtualization-based information;
storage-based information;
cloud-based information;
server-based information;
architecture-based information;
website-based information;
quality of service information; and
database information.

5. The method of claim 1, further comprising communicating a command to the host device to cause the host device to install the installation package.

6. The method of claim 1, further comprising determining, prior to communicating the installation package, that a version of a controller is already installed on the host device, the controller operable to configure the probe.

7. The method of claim 1, further comprising determining whether the installation of the installation package was successful.

8. The method of claim 1, wherein the second set of discovery information is received from the host device and another source.

9. A system, comprising:
a memory operable to store instructions, the instructions comprising a set of pre-defined rules for determining, in response to the first and second sets of discovery information, a metric associated with the host device to be monitored;
a processor communicatively coupled to the memory and operable, upon executing the instructions, to:
access, in response to a request to monitor a host device, a first set of discovery information associated with the host device, the first set of discovery information indicating at least one characteristic of the host device;
determine, based on the first set of discovery information, a second set of discovery information associated with the host device;
determine, based on the first and second sets of discovery information and based on the set of pre-defined rules, a metric associated with the host device to be monitored; and
an interface operable to communicate, based on the metric to be monitored, an installation package to the host device, the installation package comprising a probe, the probe configured to monitor the metric.

10. The system of claim 9, wherein the first set of discovery information comprises one or more of:
a type of operating system installed on the host device;
a network protocol for communicating with the host device; and
a service running on the host device.

11. The system of claim 10, wherein the type of operating system installed on the host device comprises one or more of:
a version of Linux;
a version of Windows;
a version of Solaris;
a version of Advanced Interactive eXecutive;
a version of HP-UX; and
a version of MAC OS X.

12. The system of claim 9, wherein the second set of discovery information further comprises one or more of:
network-based information;
application-based information;
virtualization-based information;
storage-based information;
cloud-based information;
server-based information;
architecture-based information;
website-based information;
quality of service information; and
database information.

13. The system of claim 9, wherein the second set of discovery information is received from the host device and another source.

14. A computer program product comprising a computer-readable storage medium having computer-readable program code embodied therewith, the computer-readable program code comprising:
computer-readable program code configured to access, in response to a request to monitor a host device, a first set of discovery information associated with the host device, the first set of discovery information indicating at least one characteristic of the host device;
computer-readable program code configured to determine, based on the first set of discovery information, a second set of discovery information associated with the host device; computer-readable program code configured to determine, based on the first and second sets of discovery information and one or more pre-defined rules, a metric associated with the host device to be monitored; and
computer-readable program code configured to communicate, based on the metric to be monitored, an installation package to the host device, the installation package comprising a probe, the probe configured to monitor the metric.

15. The computer-readable storage medium of claim 14, wherein the first set of discovery information comprises one or more of:
a type of operating system installed on the host device;
a network protocol for communicating with the host device; and
a service running on the host device.

16. The computer-readable storage medium of claim 15, wherein the type of operating system installed on the host device comprises one or more of:
a version of Linux;
a version of Windows;
a version of Solaris;
a version of Advanced Interactive eXecutive;
a version of HP-UX; and
a version of MAC OS X.

17. The computer-readable storage medium of claim 14, wherein the second set of discovery information further comprises one or more of:
network-based information;
application-based information;
virtualization-based information;
storage-based information;
cloud-based information;
server-based information;
architecture-based information;
website-based information;
quality of service information; and
database information.

18. The computer-readable storage medium of claim 14, the computer-readable program code further configured to determine the second set of discovery information based on a pre-defined policy.

19. The computer-readable storage medium of claim 14, the computer-readable program code further configured to communicate a command to the host device to cause the host device to install the installation package.

20. The computer-readable storage medium of claim 14, the computer-readable program code further configured to determine, prior to communicating the installation package, that a version of a controller is already installed on the host device, the controller operable to configure the probe.
